(19) United States
(12) Patent Application Publication
(10) Pub. No.: US 2016/0263912 A1
(43) Pub. Date: Sep. 15, 2016

(54) Paper for an Opaque Label in a Dry and Wet Environment and Thus Obtained Label

(71) Applicant: PAPETERIE ZUBER RIEDER, Boussieres (FR)

(72) Inventors: Marie Martinet, Granges Sur Lot (FR); Sylvain Richert, Arc Et Senans (FR)

(21) Appl. No.: 15/165,137

(22) Filed: May 26, 2016

Related U.S. Application Data
(62) Division of application No. 12/515,537, filed on May 20, 2009, now abandoned.

(30) Foreign Application Priority Data
Nov. 20, 2006 (FR) 0610122

(51) Int. Cl. B41J 3/407; D21H 19/82; B05D 1/02; D21H 19/38

(52) U.S. Cl. CPC B41J 3/4075; D21H 19/38; D21H 19/82; B05D 1/02

(57) ABSTRACT

A paper for a label which has an uncoated basic paper substrate on a verso side of which there is applied at least one coat of a liquid polymer, into which is incorporated one of an opacifier and an opacifying filler, intended to give product opacity in a dry state and in a wet state, adding to the opacity of the uncoated basic paper substrate so as to create a coat that is opaque and limits the ingress of water, between a product that is to be labeled and the uncoated basic paper substrate for use of the product in a wet environment or that is to be immersed in water, while at the same time preserving the qualities of the label.

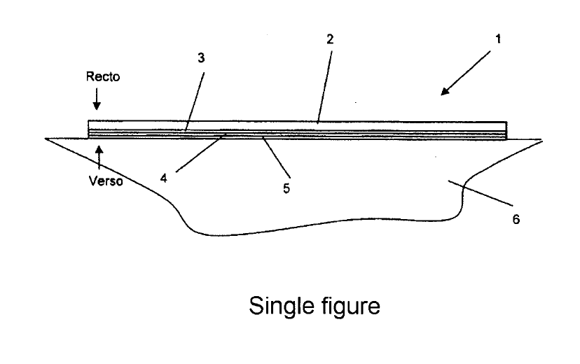

### BACKGROUND

(1) Field of the Invention

The present invention falls into the field of papermaking, and more specifically into the field of the making of uncoated paper, with a view to creating labels which, on their recto side, bear the desired information and are intended to be affixed to any substrate.

This may be any kind of packaging, but the more specifically targeted field is that of bottles intended for wines or spirits, liable through their very nature to be stored in a wet environment, such as the refrigerator, an ice bucket or any other method of storage, preservation or display intended, for example, to cool them and keep them at an appropriate temperature.

(2) Prior Art

In this particular field, it has been noted that contact between the verso side of the label and the bottle, by means of an adhesive, was not enough to maintain the original appearance of the label when subjected to moisture, particularly when immersed in water.

Now, printing substrates, particularly those with high brightness and high opacity, are enjoying sustained growth and this emerging demand requires new solutions.

This is because it is difficult, at the present time, to meet all the quality criteria required of a label with good persistence, which are as follows:
white paper has to maintain an intense brightness for esthetic reasons,
it has to display heightened opacity in a dry environment and in a wet environment,
the label has to maintain its original appearance after it has been through a wet environment,
the paper has to withstand water, for example from an ice bucket.

It is therefore desirable for the label always to maintain good opacity, whatever the environment in which it is located (air or water), and this is not always the case at the present time.

Another problem stems from the fact that, upon contact with water, water seeps in under the paper, causing air bubbles to appear, this resulting in a certain loss of attractiveness.

To date, labels available on the market have not satisfactorily met the four criteria listed above. Brightness and opacity in the dry state are obtained relatively often, but water resistance and opacity in the wet state are insufficient when immersion is of long duration, for example at least one hour as far as sessions in the “ice bucket” are concerned.

### SUMMARY OF THE INVENTION

It is an object of the present invention to remedy these disadvantages and to meet the aforementioned quality criteria. To this end, the invention relates to a paper for a label, characterized in that it consists of an uncoated basic paper substrate to the verso side of which there is applied, by any means, at least one coat of a liquid polymer, into which is incorporated an opacifier or opacifying filler, intended to give said product opacity in the dry state and in the wet state, adding to the opacity of the uncoated basic paper substrate, so as to create a coat that is opaque and limits the ingress of water, between the product that is to be labeled and the uncoated basic paper substrate, for use of the product in a wet environment or that is to be immersed in water, while at the same time preserving the qualities of the label.

This then yields a coat that limits the spread of moisture between the paper and the substrate.

This coat may be laid down away from the papermaking line or alternatively on-line.

Of course, apart from the bottle market already mentioned, this type of label according to the invention may be extended to any kind of application in which an improvement in opacity in the wet state and maintained appearance of the paper are important factors.

The invention also relates to the features which will become evident from the description which will follow, and which are to be considered in isolation or in any technically feasible combination.

### BRIEF DESCRIPTION OF THE DRAWINGS

This description, which is given by way of nonlimiting example, will provide a better understanding as to how the invention may be embodied, with reference to the attached drawings, in which:

The single FIGURE schematically depicts, in cross section and on an enlarged scale, a label according to the invention, affixed for example to a bottle.

### DETAILED DESCRIPTION OF THE PREFERRED EMBODIMENT(S)

The label 1 denoted overall in the FIGURE is obtained from an uncoated paper, that is to say from a paper which has not, on its recto side, received a surface coat aimed at modifying its appearance.

In any event, the label 1 is intended to receive on its recto side information, so that it can thereafter be affixed to any substrate 6, particularly a glass bottle.

According to the invention, the paper for a label consists of an uncoated basic paper substrate to the verso side of which there is applied by any means at least one coat of a liquid polymer, into which is incorporated an opacifier or opacifying filler, intended to give said product opacity in the dry state and in the wet state, adding to the opacity of the uncoated basic paper substrate, so as to create a coat that is opaque and limits the ingress of water, between the product that is to be labeled and the uncoated basic paper substrate, for use of the product in a wet environment or that is to be immersed in water, while at the same time preserving the qualities of the label, that is to say its initial appearance (particularly brightness and opacity) and water resistance.

The liquid polymer applied to the verso side thereof has binder properties.

The liquid polymer used may be a water-based latex or alternatively may be a solvent-based latex.

Advantageously, the liquid polymer is applied to the verso side of the label by using a coating or spraying method.

According to another feature of the invention, incorporated into the liquid polymer product is an opacifier or opacifying filler intended to give said product opacity in the dry state or the wet state, which adds to the opacity of the uncoated paper substrate 2.

As a preference, the opacifier incorporated into the liquid polymer is a titanium, so as to give said product an intense brightness and an intense opacity which adds to the brightness and opacity of the paper substrate.

At the present time, titanium is the most opaque product on the market.

Of course, it could be replaced with kaolin, talc, carbonate or titanium substitutes.

The paper will receive one or two coats 3, 4 of liquid polymer on its verso side according to the dry-state and wet-state brightness and opacity to be obtained.

In the latter instance, the coat is laid down either as a single 3+4 application, or as two applications, the first coat 3 of polymer product being filled with titanium in order to give it its brightness and its opacity, the second coat 4, which may or may not contain titanium, limiting the ingress of water through the paper 2.

According to an improvement of the invention, a liquid polymer of a different type is added en masse during the manufacture of the uncoated basic paper substrate so as to increase the tear strength of the paper when the latter is subjected to an aqueous environment.

As a preference, the liquid polymer is of the epichlorohydrin type.

Finally, the uncoated basic paper substrate 2, already coated 3, 4, later has an adhesive 5 laid down on the verso side on top of the coat(s) of polymer.

The making of a label 1 from a paper as has just been described involves the following steps:
choosing the quality of the uncoated basic paper substrate 2, according to its basis weight, its shade and its composition;
cold-spraying or coating the verso side of the uncoated basic paper substrate 2 with a liquid polymer 3, 4, mixed with an opacifier, with a view to forming a coat of intense brightness and intense opacity;
possibly applying a second coat of polymer, which may or may not be mixed with an opacifier, laid down on the first coat and limiting the ingress of water through the paper 2;
applying an adhesive 5 to the coat(s) of polymer 3, 4;
printing the labels on the recto side of the paper 1;
cutting out the labels 1;
applying, the label 1 to a substrate 6, by any means.

1-31. (canceled)

32. A method for making a paper label, the method comprising steps of:
preparing an uncoated basic paper substrate with adding an additional liquid polymer consisting of epichlorohydrin in masse during manufacture of the uncoated basic paper substrate, said uncoated basic paper substrate having a verso side and a recto side opposite said verso side, said recto side being uncoated, said additional liquid polymer being configured to increase tear strength of the paper when the paper label is used in a wet environment or immersion in water, while at the same time preserving qualities of the paper label,
applying to the verso side of the uncoated basic paper substrate at least one first coat of a first liquid polymer having one of an opacifier and an opacifying filler configured for product opacity in a dry state and in a wet state, said at least one first coat being opaque and configured to limit the ingress of water between a product that is to be labeled and the uncoated basic paper substrate.

33. The method according to claim 32, wherein it comprises steps of:
choosing the quality of the uncoated basic paper substrate according to its basic weight, its shade and its composition;
applying a second coat of the first liquid polymer laid down on the first coat and limiting the ingress of water through the uncoated basic paper substrate,
applying an adhesive to the second coat,
printing the paper label on the recto side of the uncoated basic paper substrate,
cutting out the paper label.

34. The method according to claim 33, wherein the first liquid polymer has binder properties.

35. The method according to claim 34, wherein the first liquid polymer is a water-based latex.

36. The method according to claim 34, wherein the first liquid polymer is a solvent-based latex.

37. The method according to claim 35, wherein the first liquid polymer is applied to the verso side thereof by using one of a coating and a spraying method.

38. The method according to claim 36, wherein the first liquid polymer is applied to the verso side thereof by using one of a coating and a spraying method.

39. The method according to claim 37, wherein the opacifier incorporated into the first liquid polymer is a titanium, configured to give said product an intense brightness and an intense opacity, which add to the brightness and opacity of the uncoated basic paper substrate.

40. The method according to claim 38, wherein the opacifier incorporated into the first liquid polymer is a titanium, configured to give said product an intense brightness and an intense opacity, which add to the brightness and opacity of the uncoated basic paper substrate.

41. The method according to claim 39, wherein at least one first coat is laid down as a single application.

42. The method according to claim 40, wherein at least one first coat is laid down as a single application.

43. The method according to claim 32, wherein it comprises steps of:
choosing the quality of the uncoated basic paper substrate according to its basic weight, its shade and its composition;
applying a second coat of a second liquid polymer without the opacifier, the second coat laid down on the first coat and limiting the ingress of water through the uncoated basic paper substrate,
applying an adhesive to the second coat,
printing the paper label on the recto side of the uncoated basic paper substrate,
cutting out the paper label.

44. The method according to claim 43, wherein the first liquid polymer has binder properties.

45. The method according to claim 44, wherein the first liquid polymer is a water-based latex.

46. The method according to claim 44, wherein the first liquid polymer is a solvent-based latex.

47. The method according to claim 45, wherein the first liquid polymer is applied to the verso side thereof by using one of a coating and a spraying method.

48. The method according to claim 46, wherein the first liquid polymer is applied to the verso side thereof by using one of a coating and a spraying method.

49. The method according to claim 47, wherein the opacifier incorporated into the first liquid polymer is a titanium, configured to give said product an intense brightness and an intense opacity, which add to the brightness and opacity of the uncoated basic paper substrate.

50. The method according to claim 48, wherein the opacifier incorporated into the first liquid polymer is a titanium, configured to give said product an intense brightness and an intense opacity, which add to the brightness and opacity of the uncoated basic paper substrate.

51. The method according to claim 49, wherein at least one first coat is laid down as a single application.
